(19) United States
(12) Patent Application Publication
(10) Pub. No.: US 2008/0085841 A1
(43) Pub. Date: Apr. 10, 2008

(54) Canola meal drilling fluid additive

(75) Inventor: Dalmain H. Brown, Bay Tree (CA)

Correspondence Address: MAYBACK & HOFFMAN, P.A., 5722 S. FLAMINGO ROAD #232, FORT LAUDERDALE, FL, 33330, US

(73) Assignee: Paloverde Environmental Ltd.

(21) Appl. No.: 11/713,417

(22) Filed: Mar. 2, 2007

(30) Foreign Application Priority Data
Oct. 5, 2006 (CA) 2,562,651

(51) Int. Cl. C09K 8/20

(52) U.S. Cl. 507/104

(57) ABSTRACT

A drilling fluid additive comprised of ground canola meal that decreases seepage loss and fluid loss of the fluid to permeable formations. The canola meal is ground to particle sizes between about 10 and 1250 microns, in particular, between about 100 to 1000 microns. This product can be added to oil or water based drilling fluids. It is environmentally safe, reduces torque and drag on a drill string, and provides viscosity in the system. The additive has a high return permeability and acid degradability.

### CROSS-REFERENCE TO RELATED APPLICATION

This application claims the priority, under 35 U.S.C. §119, of Canadian Patent Application Serial No. 2,562,651, filed Oct. 5, 2006, the entire disclosure of which is hereby incorporated herein by reference in its entirety.

### STATEMENT REGARDING FEDERALLY SPONSORED RESEARCH OR DEVELOPMENT

n/a

### BACKGROUND OF INVENTION

1. Field of the Invention

The present invention relates to a biodegradable drilling fluid additive to reduce seepage loss and fluid loss to the bore wall encountered during the drilling operations.

2. Description of Related Art

Most rotary drilling methods to recover hydrocarbons such as oil and/or gas from subterranean deposits require the use of drilling fluids, which are circulated down the well bore being drilled during drilling operations.

Drilling fluids serve many functions including cleaning the cuttings from the face of the drill bit, transporting the cuttings to the ground surface, cooling the drill bit, lubricating the drill bit and drill stem, and increasing the stability of the borehole. Drilling fluids also have varying lubricative properties that can help reduce torque and drag on the drill pipe.

Typically drilling fluids may be water-based, using a base of fresh water or salt water. A drilling fluid may also be oil-based, using for instance, diesel oil or may be an invert emulsion, in other words, a water-in-oil emulsion. Additives must be added to these drilling fluids to overcome specific well bore problems, and suited to encountered subterranean formations to thereby create an appropriate well fluid.

Common problems encountered during drilling operations include fluid loss and/or seepage loss. The term “fluid loss” will, in this disclosure be used to refer to the more significant loss of drilling fluid that often occurs in the upper hole, where porosities and fractures are usually larger than deeper in the hole, nearer to zones of productive interest. The term “seepage loss” will, in this disclosure be used to refer to the less significant loss of the drilling fluid in the zones of lesser porosities and fracture sizes. Fluid loss and seepage loss occur when the liquid fraction from the drilling fluid seeps into the surrounding formation, leaving the solid particulate portions of the drilling fluid in the well bore. Fluid loss and seepage loss can occur to any type of formation when the size of the particles in the well fluid is smaller than the size of the pore openings of a formation. This loss occurs as a result of the actual filtration of the solids by the formation due to a differential pressure from the fluid column to the formation.

When fluid or seepage loss occurs, the drilling fluid becomes more viscous and a filter cake can form in the well bore. Formation of a thick filter cake increases the risk that the cake may be eroded by circulating drilling fluid, which may cause the drill pipe to stick, or may cause reduced hydrostatic pressure, and partial collapse of the walls of the borehole during tool removal. A thin impervious filter cake on the sides of the borehole is necessary in order to control the filtration characteristics of the drilling fluid, since the pressure in the borehole is greater than the pressure in the formation.

There are many causes of fluid loss and seepage loss and some non-limiting examples include natural fractures in the rocks drilled, induced fractures when pressure in the drilling fluid exceeds fracturing stress of the earth, cavernous formations, and formations with high permeability.

In order to address fluid loss and seepage loss, it has been common to add any number of materials to the drilling fluid to prevent the flow of drilling fluid outwardly in a formation. Such additives may include various fibrous and granular materials of different micron sizes. When circulating drilling fluid in a well, such materials enter the pores of formations, plugging off any leaks.

The overall particle size distribution is important when addressing both fluid loss and seepage loss. Particulate material added should be able to stop the porosity and significantly reduce the movement of fluid into the bore wall.

Of particular concern regarding potential well performance is the ability of a fluid loss/seepage loss agent to be removed from the porosities/fractures of the intended production zone. It is therefore critical that fluid loss/seepage loss agents should be able to be flushed out again (return permeability), or be removed by acid (acid degradability).

Numerous organic and inorganic additives are known for use in both water-based and oil-based muds. Organic additives are preferred for their cost effectiveness and because they are often safer environmentally than inorganic additives. They are often easier to remove, providing a more free flowing production zone.

Many different types of organic materials have been used to address seepage loss. Some non-exhaustive examples of patents addressing the problem of seepage loss or fluid loss include U.S. Pat. No. 6,399,545 issued to Rose which describes the use of fruit pomace in drilling fluid additives. U.S. Pat. No. 5,071,575 issued to House et al. describes using ground oat hulls in a limited particle size range, with the addition of one or more agricultural by-products such as ground citrus pulp to decrease seepage loss. U.S. Pat. No. 5,229,018 issued to Forrest teaches the use of peanut hulls as an additive. U.S. Pat. No. 5,076,944 issued to Cowan et al. discloses the use of cotton burs in combination with one or more of ground oat hulls, ground corn cobs, hydrophobic organophilic water wettable cotton, ground citrus pulp, ground rice hulls, ground nut shells, and mixtures thereof as a seepage loss additive. U.S. Pat. No. 5,801,127 issued to Duhon, Sr. discloses the use of ground olive pulp as an additive to prevent fluid loss in both water-based and oil-based drilling fluid.

While organic additives are often less expensive than inorganic additives, and are usually environmentally safe, not all organic additives can provide a sufficiently broad particle size distribution to prevent seepage loss or fluid loss over a broad range of drilling conditions. Some additives are useful as lost circulation additives, while proving ineffective for fluid or seepage loss. Furthermore, some additives affect the permeability of the surrounding formation. Also, some organics tend to form sticky agglomerations (mud balls) that diminish bit penetration significantly. Frequently these sticky accumulations form mud rings as the fluid attempts to carry them up the bore wall.

As every drilling operation is different, there is still a need for a drilling fluid additive that has a broad particle size distribution that will address fluid loss and/or seepage loss in various drilling conditions, that will be compatible with a water-based or oil-based drilling fluid and that will not have detrimental effects on the flow properties of a surrounding subterranean formation. There is also a need for such an additive which will not adversely affect the lubricative properties of the well fluid.

### SUMMARY OF THE INVENTION

This invention relates to an organic additive for reducing seepage or fluid loss during drilling operations. In accordance with one aspect of the present invention, there is provided an additive for drilling fluid for use in the drilling of wells including ground canola meal.

In accordance with an embodiment of the present invention, the additive includes canola meal particles that are less than 1500 microns in size and, in particular, between about 10 and about 1250 microns. In an exemplary embodiment, the additive includes particles that are between about 100 to 1000 microns. In one embodiment of the invention, about 75% of the particles are less than about 150 microns. In an alternate embodiment, about 21% of the particles are less than about 150 microns.

In accordance with yet another aspect of the present invention there is provided a method for carrying out drilling operations in a well bore extending into a subterranean formation including circulating a drilling fluid into and out of a well during drilling operations, wherein the drilling fluid contains an additive including ground canola meal.

Ground canola meal provides a readily biodegradable additive that remains in suspension under wide temperature variations and enhances lubrication in the drilling system, as well as reducing torque and drag. The additive can be used with either a water-based or oil-based system and not only provides an environmentally safe product, but a highly effective seepage loss and fluid loss additive that minimizes adverse effects on a subterranean formation.

While the invention has been broadly described for seepage loss, it will also be understood by a person skilled in the art that it can be applied in the control of fluid loss applications. The structure and method of the present invention as well as other features and advantages over other structures and methods known in the art can be better understood with reference to the detailed description which follows.

### DETAILED DESCRIPTION OF THE INVENTION

Canola meal is obtained from canola seed (typically obtained from genus Brassica napus L. or Brassica campestris L., or a blend thereof) which is traditionally crushed and solvent extracted in order to separate the oil from the meal. The process generally includes the steps of seed cleaning, seed pre-conditioning and flaking, seed cooking, pressing the flake to mechanically remove a portion of the oil, solvent extraction of the press cake to remove the remainder of the oil, and desolventizing and toasting of the meal. During this process, plant gums are removed from the oil. The gums are obtained during the refining of canola oil, and typically consist of glycolipids, phospholipids and variable amounts of triglycerides, sterols, fatty acids. In Canada and the United States, these gums are typically returned to the meal, however, this may not be the case in other countries.

The resulting meal typically contains approximately 36 percent protein, 12-16 percent crude fiber, 2 percent oil, 42-44 percent starches and sugars. Due to the addition of such gums, the meal also contains approximately 2 to 4 percent plan mucilaginous material. The percentages may vary slightly from meal to meal depending on growing conditions and plant variety. Canola meal can be obtained commercially from ADM, Lloydminster, Alberta.

The canola meal is ground to a suitable particle size using conventional methods known to those skilled in the art, such as an Alpine Contraplex pin mill, a hammer mill or a Schutz-O'Neil pulverizer. Different methods have been developed to measure particle size distribution. Air classification equipment or conventional sizing methods such as screening, or other means known in the art can be used for separation of desired ranges of particle sizes.

The meal is ground to particle sizes of less than about 1500 microns in size and, in particular, to particles sizes that are from between about 10 to about 1250 microns. In an exemplary embodiment of the present invention, the particle size range is between about 100 to about 1000 microns. In one embodiment of the present invention, about 80% of the canola meal particles are ground to less than about 750 microns. In another embodiment and for most seepage loss applications, an improvement in fluid loss function has been obtained with an additive including more finely ground material using canola meal ground wherein about 75% of particles are less than about 150 microns in size. Favorable results during drilling operations have also been obtained with coarser material wherein about 21% of the particles are less than about 150 microns. The particles sizes and distributions may vary depending on the drilling and subterranean formation conditions encountered.

The following particle size distributions have also been postulated and experimented with, and are known to work:
a particle size distribution wherein the canola meal particles are in a range of between about 10 and 1250 microns, wherein about 20% of the particles are less than 150 microns and 80% are between 350 microns to 750 microns;
a particle size distribution wherein the canola meal particles are in a range of between about 10 and 1250 microns, about 30% are between 350 and 750 microns and about 70% are less than 150 microns;
a particle size distribution wherein the canola meal particles are in a range of between about 10 to 1250, and about 80% are less than 750 microns, about 50% are less than 345 microns, and about 10% are less than 112 microns; and
a particle size distribution wherein the canola meal particles are less than 1000 microns and at least 30% are less than 100 microns.

The particle sizes and distributions can be used in all types of drilling fluids, and the additive is compatible with water-based or oil-based drilling fluids. The specific gravity of the ground canola meal is approximately 0.6.

During drilling operations, the particles of the ground canola meal get transported by the drilling fluid and plug holes in the pores in the surrounding formation. The ground canola meal according to the present invention includes relatively coarse fibrous cellulose particles that provide seepage loss protection where larger fractures are encountered down-hole. These particles are flexible, clinging and thin, compared to their size, thus offering the likelihood of finding their position in the filter cake protecting the relatively small fractures found in a formation. Furthermore, due to the presence of starches, sugars and proteins, and fibers found in the ground canola meal, the particles will enter the pores in a formation and expand or swell, and therefore seal off the formation. The constituents in the ground canola meal thereby work together to functionally diminish seepage loss and provide an advantage not available in the materials disclosed in the prior art.

The additive of the present invention is incorporated into a drilling fluid as soon as seepage loss control is required. Wetting agents and/or emulsifiers are not necessary when this additive is used in a drilling fluid system. The most effective use is based on an early application during drilling. The ground canola meal product is introduced into drilling fluid that is already circulating in the well bore. With this product incorporated into the drilling fluid, drilling operations are carried out using conventional techniques well known to those skilled in the art.

The method of carrying out drilling operations according to the present invention and thereby decreasing seepage loss or fluid loss from the borehole into a subsurface formation generally includes contacting together a drilling fluid and a drilling fluid additive including ground canola meal as described above. The drilling fluid additive of the present invention may be used in a pill or slug by mixing in a separate tank the additive with a small portion of the drilling fluid to be treated, and then subsequently adding this mixture of the additive and drilling fluid by blending or mixing the mixture of additive and drilling fluid with the entire volume of the fluid used in the well operation. In the practice of the method of the present invention for operating a well, the drilling fluid including both drilling fluid and additive are circulated into and out of the well bore.

The amount of additive described above, that is added to the drilling fluid needs only to be an amount which is effective in reducing the seepage loss to the desired extent. In particular, the amount of additive added to a drilling fluid is from about 1% to 3% by weight of the drilling fluid, which includes 1%, 1.5%, 2%, 2.5% and 3%. To create a well fluid for most applications, it has been found that a concentration of 3% by weight of drilling fluid achieves the most favorable result. In particular, there is added from about 2 kg to about 40 kg of the ground canola meal per m³ of the drilling fluid, and more particularly, from about 5 kg to about 30 kg.

The ground canola meal of this invention may be added to drilling fluids that are, either water-based or oil-based utilizing techniques known to a person skilled in the art.

In an exemplary embodiment, the additive of the present invention is added incrementally to the drilling fluid over a period of days, thus providing fluid with the lubricative characteristics that keep a drilling program from needing emergency lubricative input, such as spotting fluids that are typically added when the drill string is stuck in the borehole. In particular, 100 to 200 kg of the additive of the present invention would be introduced into the system each 12-hour period, with increased amounts added if necessary until fluid loss of the mud system is acceptable or optimum.

The additive of the present invention minimizes adverse chemical effects in the well bore, reduces torque and drag appreciably on the drill string, and prevents seepage loss. Additionally, the additive of the present invention is biodegradable. The additive of the present invention not only performs a seepage loss function, but may also act as a viscosifier where increased viscosity is required to carry the cuttings adequately and to clean the bore wall.

The additive of the present invention is stable and does not degrade at temperatures encountered during drilling operations. A wide variety of temperatures can be encountered depending on the area and time of year. For instance, in one embodiment of the present invention, the additive may be used during drilling operations ranging from as low as −40° C. to as high as 90° C.

The additive of the present invention leaves considerably less acid insolubles than most conventional additives used for seepage or fluid loss since the finished product naturally disintegrates in the presence of acid. Acid solubility is critical when the production zone must be cleared to allow maximum porosity, and therefore well flow. Particulate materials that are persistent in the pore throats and cannot be removed by acid treatment have the potential for diminishing available porosity, and thus, flow of hydrocarbons from the well. The additive of the present invention is at least 70% acid soluble. This means the product can be removed from the bore wall in the area of interest. If a seepage loss additive is not acid soluble, it will remain in the bore wall and plug the pores of the formation. This will reduce production.

The invention is illustrated by way of the following non-limiting examples.

### EXAMPLES

### Example 1

### Seepiage Loss

A sand bed test was conducted to establish a relative measure of seepage loss of a base fluid with three different test additives. The test was repeated for three different additive compositions.

An inhibitive water-based polymer mud was prepared containing the following: amine inhibitor, bleach, magnesium oxide, PacSL™ (polyacrilamide cellulose, a commercially available seepage agent) and a fluid lubricant. The mud was mixed and stirred for 1 hour and regular bentonite was added to the mud. The mud was allowed to sit for 1 day to allow the bentonite to settle out as super saturation of H₂O by gel could see some settlings. The mud was decanted off and set aside for the tests. A filter press cylinder was filled with a half cup of 70/140 mesh frac sand. Bleach and magnesium oxide were added to maintain a pH of 9.5 to 10.0. The sample was stirred for 30 minutes and 250 ml of the test additive was poured on top of the sand in the cell. The cell was capped and 100 psi was applied to the cell.

The concentration of the test additive in the sample was increased from 20 kg/m³ to 40 kg/m³ and a second series of tests were performed.

The reference to Test Additive A refers to the additive of the present invention produced on an Alpine Contraplex pin mill where the particles are less than 1000 microns in size and at least 30% of the ground canola meal particles are less than 100 microns.

Test Product UltraSeal™ refers to a blend of specific micro sized cellulose fibers, combined in certain concentrations and is available from M & D Industries of Louisiana. Test Product Fiber Fluid Fine refers to a product made by pulverizing cellulose fiber and is available from Grinding and Sizing Co., Inc., Lufkin, Tex. The results were as follows:

TABLE 1

| | Fluid Loss at 20 | Fluid Loss at 40 |
|---|---|---|
| | km/m³ of | kg/m³ of |
| Test Additive | Starting Sample | Starting Sample |
| (1) Test Additive A | 17.8% | 6.2% |
| (2) Ultra Seal XP ™ | 65.3% | 17.0% |
| (3) Fiber Fluid Fine | 70% | 68.0% |

### Example 2

### Acid Degradability

Acid solubility was tested on two additives and the acid insolubles were measured and compared.

Acid solubility was tested by placing test additives in 19% HCl and heated to 45° C. in a water bath for 24 hours. The test additives were then filtered through a 1.5 micron filter under vacuum. The solids collected on the filters were weighed and the difference of starting weights of the samples minus the solids on the filters were the acid insoluble portions.

Test Additive A refers to the additive of the present invention described in Example 1.

The results that were obtained follow in Table 2.

TABLE 2

| Test Additive | % Acid insolubility |
|---|---|
| Ultra Seal ™ | 47.3% Acid insoluble |
| Test Additive A | 28.3% Acid Insoluble |

### Example 3

### Return Permeability

Any fluid injected into a well or formation may have detrimental effects on the flow properties of the formation. Return permeability measurements reveal formation damage caused by such fluids. A return permeability test includes measuring permeability of a rock core sample before and after it has been exposed to the fluid.

The return permeability of Test Additive A was tested. Test Additive A refers to the additive of the present invention described in Example 1. The additive was suspended in a water based mud system and poured onto a Berea sandstone plug. The leakoff volume was measured over a 240 minute period and had 10.2 ml penetrating linear depth of 5.28 cm. The return permeability was shown to be 100%. Table 3 shows the test parameters and Table 4 shows the leakoff summary.

TABLE 3
CORE & TEST PARAMETERS

| | | | |
|---|---|---|---|
| Well Location: | N.A. | Length (cm): | 6.35 |
| Core I.D.: | BEREA | Diameter (cm): | 3.76 |
| Depth (m): | N.A. | Pore Volume (cm³): | 12.27 |
| Porosity (fraction): | 0.174 | Mud Overbalance | 3448 |
| | | Pressure (kPag): | |
| Air Permeability (mD): | 150 | Concentration of | 18 |
| | | Test Product A (g/1): | |
| Test Temperature (° C.): | 82 | Net Overburden | 6895 |
| | | Pressure (kPag): | |

PERMEABILITY SUMMARY

| | Permeability | Regain |
|---|---|---|
| Test Phase | (mD) | Permeability (%) |
| Initial Permeability to Mineral Oil | 68 | Baseline Permeability |
| (Forward Direction) | | |
| Overbalance Mud Circulation with | — | — |
| Test Product A | | |
| (Reverse Direction) | | |
| Regain Permeability to Mineral Oil | 68 | 100.0% |
| (Forward Direction) | | |

TABLE 4
LEAKOFF CHARACTER SUMMARY

| | |
|---|---|
| Leakoff Exposure Time | 240 Minutes |
| Time to Sealoff | Did not seal off |
| Total Leakoff Volume after 240 minutes | 10.2 ml |
| Linear Filtrate Penetration Depth | 5.28 cm* |
| after 240 minutes of circulation | |

*Assuming 100% Filtrate Sweep Efficiency

Although the exemplary embodiments have been described, it will be appreciated by those skilled in the art to which the present invention pertains that modifications, changes and improvements may be made without departing from the spirit of the invention defined by the claims.

What is claimed is:

1. A drilling fluid additive for use in the drilling of wells comprising ground canola meal.

2. The drilling fluid additive according to claim 1, wherein said ground canola meal includes a naturally occurring mucilaginous component.

3. The drilling fluid additive according to claim 1, wherein said ground canola meal comprises canola meal particles of less than about 1500 microns.

4. The drilling fluid additive according to claim 3, wherein said canola meal particles are between a range of about 10 to 1250 microns.

5. The drilling fluid additive according to claim 4, wherein said canola meal particles are between a range of about 100 to 1000 microns.

6. The drilling fluid additive according to claim 5, wherein about 80% of said canola meal particles are less than about 750 microns.

7. The drilling fluid additive according to claim 5, wherein about 75% of said canola meal particles are less than about 150 microns.

8. The drilling fluid additive according to claim 6, wherein about 75% of said canola meal particles are less than about 150 microns.

9. The drilling fluid additive according to claim 5, wherein about 21% of said canola meal particles are less than about 150 microns.

10. The drilling fluid additive according to claim 6, wherein about 21% of said canola meal particles are less than about 150 microns.

11. The drilling fluid additive according to claim 1, wherein said additive is present in a concentration in a range of about 1 to 3% by weight of said drilling fluid.

12. A drilling fluid comprising one of a water-based fluid and an oil-based fluid, along with sufficient additive of claim 1 to decrease seepage loss of said drilling fluid to a formation.

13. A drilling fluid comprising one of a water-based fluid and an oil-based fluid, along with sufficient additive of claim 1 to decrease fluid loss of said drilling fluid to a formation.

14. A method for carrying out drilling operations in a well bore extending into a subterranean formation, which comprises circulating a drilling fluid into and out of the well bore wherein the drilling fluid contains an additive comprising ground canola meal particles.

15. The method according to claim 14, wherein the canola meal particles are ground to less than about 1500 microns.

16. The method according to claim 15, wherein the canola meal particles are ground to a range of between about 10 to 1250 microns.

17. The method according to claim 16, wherein about 80% of the canola meal particles are less than about 750 microns.

18. The method according to claim 16, wherein about 75% of the canola meal particles are less than about 150 microns.

19. The method according to claim 17, wherein about 75% of the canola meal particles are less than about 150 microns.

20. The method according to claim 16, wherein about 21% of the canola meal particles are less than about 150 microns.

21. The method according to claim 17, wherein about 21% of the canola meal particles are less than about 150 microns.

22. The method according to claim 14, wherein the ground canola meal is added in a concentration of 1 to 3% by weight of the drilling fluid.

23. The method according to claim 14, wherein the drilling fluid is water-based.

24. The method according to claim 14, wherein the drilling fluid is oil-based.

25. Use of the drilling fluid additive according to claim I as a lubricity agent during drilling operations.

26. Use of the drilling fluid additive according to claim 1 as a viscosifier during drilling operations.

27. The drilling fluid additive of claim 1, wherein at least 70% of said additive is acid soluble.

28. In combination with a drilling fluid for use in the drilling of wells, a drilling fluid additive comprising ground canola meal.
